(19) United States
(12) Patent Application Publication
(10) Pub. No.: US 2008/0016156 A1
(43) Pub. Date: Jan. 17, 2008

(54) Large Scale Real-Time Presentation of a Network Conference Having a Plurality of Conference Participants

(76) Inventors: Sean Miceli, Sunnyvale, CA (US); Victor Ivashin, Danville, CA (US); Steve Nelson, San Jose, CA (US)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/457,285

(22) Filed: Jul. 13, 2006

(51) Int. Cl. G06F 15/16

(52) U.S. Cl. 709/204

(57) ABSTRACT

A conferencing method is described. The method includes connecting a plurality of conference participants to a conferencing server. Each conference participant generates conferencing content sent to the conferencing server. A plurality of conference viewers is connected to a video streaming server. At least a portion of the conferencing content is passed from the conferencing server to the video streaming server and is streamed to the plurality of conference viewers. A conferencing system incorporating the method is also described.

### CROSS REFERENCE To RELATED APPLICATIONS

This application is related to U.S. patent application Ser. No. 10/192,130 filed on Jul. 10, 2002 and entitled “Method and Apparatus for Controllable Conference Content via Back-Channel Video Interface;” U.S. patent application Ser. No. 10/192,080 filed on Jul. 10, 2002 and entitled “Multi-Participant Conference System with Controllable Content Delivery Using a Client Monitor Back-Channel;” U.S. patent application Ser. No. 11/051,674 filed on Feb. 4, 2005 and entitled “Adaptive Bit-Rate Adjustment of Multimedia Communications Channels Using Transport Control Protocol;” U.S. patent application Ser. No. 11/199,600 filed on Aug. 9, 2005 and entitled “Client-Server Interface to Push Messages to the Client Browser;” and U.S. patent application Ser. No. 11/340,062 filed on Jan. 25, 2006 and entitled “IMX Session Control and Authentication” all of which are incorporated herein by reference.

### BACKGROUND

Conferencing systems are used to facilitate communication between two or more participants physically located at separate locations. Systems are available to exchange live video, audio, and other data to view, hear, or otherwise collaborate with each participant. Common applications for conferencing include meetings/workgroups, presentations, and training/education. Today, with the help of videoconferencing software, a personal computer with an inexpensive camera and microphone can be used to connect with other conferencing participants. Peer-to-peer videoconferencing software applications allow each participant to see, hear, and interact another participant and can be inexpensively purchased separately. Motivated by the availability of software and inexpensive camera/microphone devices, videoconferencing has become increasingly popular.

Video communication relies on sufficiently fast networks to accommodate the high information content of moving images. Audio and video data communication demand increased bandwidth as the number of participants and the size of the data exchange increase. Even with compression technologies and limitations in content size, bandwidth restrictions severely limit the number of conference participants that can readily interact with each other in a multi-party conference.

Video streaming technology is available that allows for a single audio/video source be viewed by many people. This has lead to conferencing systems referred to as “one to many systems” that enable a single presenter to speak to many passive viewers. In a one-to-many conference, the “one” is typically denoted as a speaker or presenter, and the “many” are an attending “audience” or viewers. A primarily unidirectional exchange, the one-to-many conference requires all audience members to be able to hear and see the activities of the speaker (i.e., the speaker's media is transmitted to all participants). For the audience members, the activities of other participants (i.e., audio and/or video media of the audience) may not be desirable, and could be detrimental to the effectiveness of the one-to-many collaboration. The speaker may, however, be interested in audience feedback to the presentation and wish to be aware of interruptions or questions. Furthermore, in some one-to-many collaboration models, the speaker can control when and who can speak, as during a question and answer period. At that time, audience members may wish to hear the participant asking a question in addition to the speaker's response. Conference systems for one-to-many collaborations therefore require more complex rules than a one-to-one collaboration.

In many instances, it may be desirable for a large audience to view a panel discussion or collaboration by a select number of experts, speakers, or presenters that are remote from one another. Unfortunately, current conference systems that allow collaboration and active participation have bandwidth restrictions that limit the number of participants, and current systems providing broadcast capability do not provide for free two-way communication. Therefore, there exists a need for some mechanism that can permit a large audience to view, and perhaps provide some feedback in the form of questions, etc., to a smaller group of active collaborators, speakers, or presenters.

### SUMMARY

Broadly speaking, the present invention fills these needs by providing large scale real-time presentation of a network conference having a plurality of conference participants. It should be appreciated that the present invention can be implemented in numerous ways, including as a process, an apparatus, a system, a device, or a method. Several inventive embodiments of the present invention are described below.

In one embodiment, a conferencing method is provided. The method includes connecting a plurality of conference participants to a conferencing server. Each conference participant generates conferencing content sent to the conferencing server. A plurality of conference viewers is connected to a video streaming server. At least a portion of the conferencing content is passed from the conferencing server to the video streaming server and is streamed to the plurality of conference viewers.

In another embodiment a conferencing system is provided. The conferencing system includes a conferencing server programmed for accepting a plurality of connections from a corresponding plurality of conference participants. The conferencing server receives multimedia content from each of the conference participants. The conferencing server also accepts a connection from a controlling client. A message can be received from the controlling client which designates one of the conference participants. The conferencing server then passes multimedia content from the designated conference participants to a video streaming server.

In yet another embodiment a conferencing system is provided including a video streaming server. The video streaming server (VSS) is programmed for accepting a plurality of network connections from a corresponding plurality of conference viewers. The VSS is programmed to also communicate with a multipoint control unit (MCU) server over a network and to receive multimedia content from the MCU server. The VSS streams the multimedia content to the plurality of conference viewers using the plurality of network connections. Additionally, The VSS further communicates with a control panel; The VSS receives question requests from the plurality of conference viewers and sends the question requests to the control panel. Upon receiving a message from the control panel identifying one of the conference viewers to ask a question, the VSS is programmed to receive multimedia data from the identified conference viewer and pass the multimedia data to the MCU server, the multimedia data including at least an audio stream.

The advantages of the present invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate like structural elements.

FIG. 1 shows an exemplary “few to many” conferencing system having a plurality of conference participants and a plurality of conference viewers.

FIG. 2 shows an exemplary computer.

FIG. 3 shows a schematic diagram of an exemplary network topology for the conferencing system shown in FIG. 1.

FIG. 4 shows a schematic block diagram showing high-level software components of the various computers interacting to provide conferencing system of FIGS. 1 and 3.

FIG. 5 shows a flowchart describing an exemplary procedure for accessing a video streaming server to passively participate in a conference.

FIGS. 6A, 6B, and 6C show exemplary graphical user interface configurations for respective conference viewer client modes.

FIG. 7 shows an exemplary control panel interface.

FIG. 8 shows a swim lane diagram providing an exemplary interaction when a question is being requested.

### DETAILED DESCRIPTION

In the following description, numerous specific details are set forth in order to provide a thorough understanding of the present invention. However, it will be apparent to one skilled in the art that the present invention may be practiced without some of these specific details. In other instances, well known process operations and implementation details have not been described in detail in order to avoid unnecessarily obscuring the invention.

FIG. 1 shows an exemplary “few to many” conferencing system having a plurality of conference participants 130 and a plurality of conference viewers 150. Conference participants 130 access conferencing server 110 to participate in a panel discussion, collaboration, or other event. A conference participant is used herein to identify a person that is a collaborator, speaker, or presenter. The conference participant may freely interject and interact with other conference participants. In one embodiment, each conference participant 130 can contribute to the discussion by providing real-time high bit-rate video and audio data and/or other multimedia content such as images, documents, and annotations, which any other conference participant can then receive. Each conference participant can interject into a conversation with their own contribution without having to first get permission from a moderator. Thus, a conference participant is a person who is permitted to freely engage in a conversation with one or more other conference participants.

Conference viewers 150 access video streaming server (VSS) 120 to receive audio, video, and other multimedia content such as images, documents, and annotations in real time. In one embodiment, VSS 120 may receive audio, video, and other multimedia content directly from conferencing server 110 via a local area network (LAN) connection 146. Conference viewers 150 generally will be able to receive a combined audio stream made up of audio streams from all conference participants 130. However, in one embodiment, each conference viewer 150 can only view one high bit-rate video stream from one of the conference participants 130, and generally cannot choose which conference participant 130 to view. Furthermore, conference viewers may be given an opportunity to ask questions by sending a signal along reverse path 157 to VSS 120 indicating a desire to ask a question, and then, after permission is granted, a low bit-rate video and/or audio signal can be sent from the conference viewer to VSS 120 encoding the individual's question.

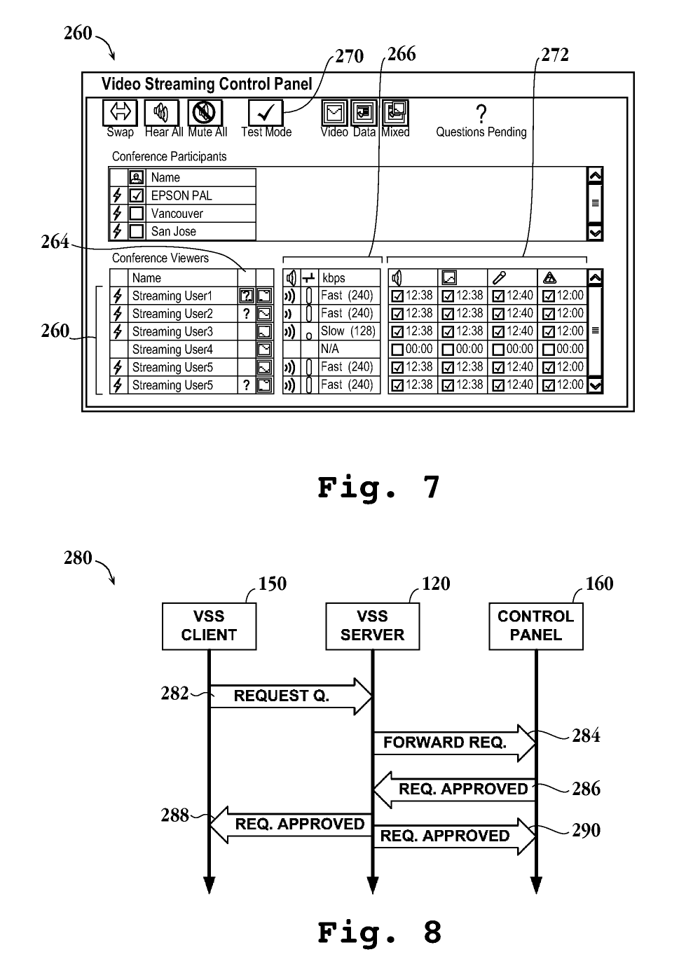

To select which video feed to send to conference viewers 150, and to permit question or feedback from conference viewers 150, a special conference participant, referred to herein as controller 140, is provided with a control panel client as will be described in greater detail below with reference to FIG. 7. Controller 140 is connected to both conferencing server 110 and VSS 120. Using the control panel client, controller 140 can designate and communicate to conferencing server 110 which video stream from conference participants 130 to send to conference viewers 150. In addition, controller 140 connects with VSS 120 to interact with conference viewers 150. Such interaction includes assistance with setting up, e.g., confirming their audio and video signals are being received, and selecting which audio and/or video feed from conference viewers 150 to send to conference participants 130 when asking a question. Other interactions are also possible, such as chatting. Chatting is the sending and receiving of instant text messages between participants.

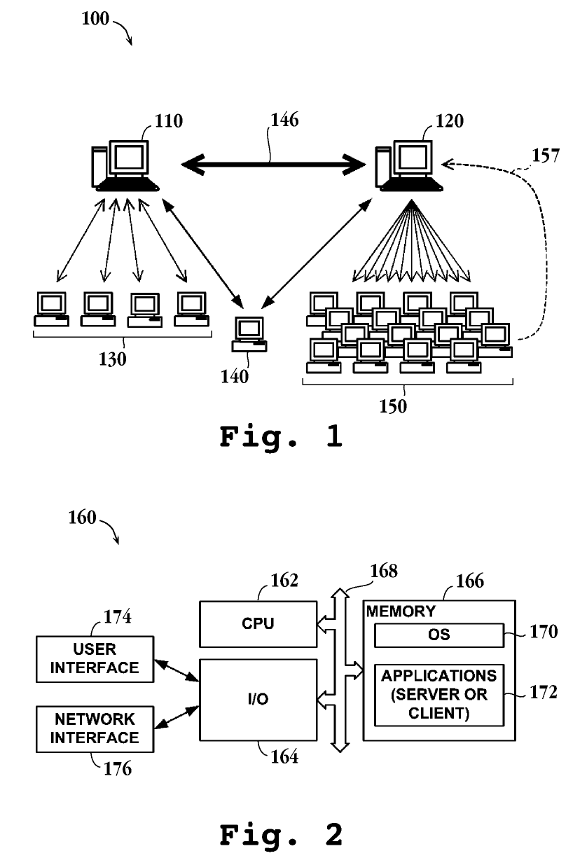

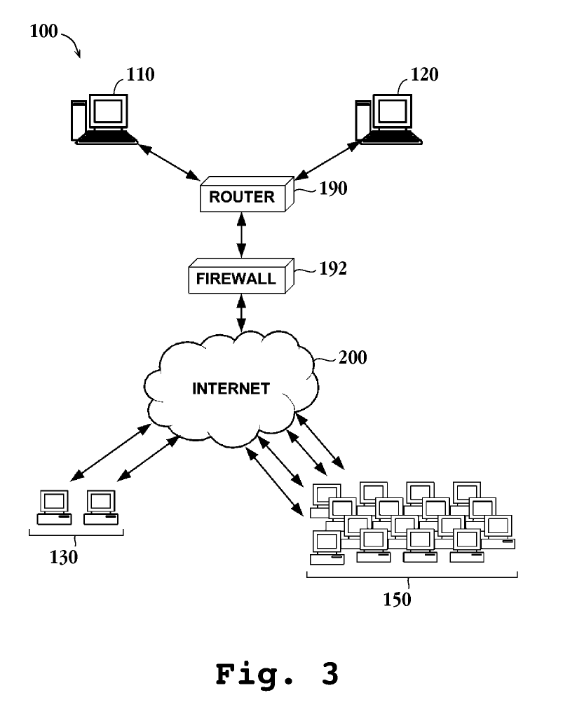

FIG. 2 shows an exemplary computer 160 having a CPU 162, input/output (I/O) ports 164, and a memory 166, which are in electronic communication via bus 168. Memory 166 includes an operation system 170 and applications 172. If computer 160 is a server, then applications 172 will include server software. If computer 160 is a client, then applications 172 will include client software. It is also possible that computer 160 act as both a server and a client, in which case, applications 172 will include server software as well as client software. Herein, the term, “server” will refer to a computer system that primarily acts as a server, and the term “client” will refer to a computer system that primarily acts as a client, although it should be understood that each can act in either capacity or both simultaneously, depending upon the software being run. Each server may serve multiple functions. For example, a single server could include conferencing server software as well as VSS software. In this case, the conferencing server 110 and VSS 120 shown in FIG. 1 could be a single computer system that includes both the conferencing server software and the VSS software. In addition, the client software for running on conference participants and conference viewers may be two separate computer programs or a single computer program with different participation and viewing modes of operation depending upon which server it is connected to, i.e., whether the client is in communication with the conferencing server software or the VSS software. Returning to FIG. 2, I/O ports 164 can be connected to external devices, including user interface 174 and network interface 176. User interface 174 may include user interface devices, such as a keyboard, video screen, and a mouse. Network interface 176 may include one or more network interface cards (NICs) for communicating via an external network.

FIG. 3 shows a schematic diagram of an exemplary network topology for the conference system 100 shown in FIG. 1. Conferencing server 110 and VSS 120 are each connected via LAN lines to router 190. Router 190 also provides connection via firewall 192 to Internet 200. Conference participants 130 and conference viewers 150 are therefore able to connect to conferencing server 110 and/or VSS 120 via the Internet, and conference server 110 and VSS 120 can connect to each other via a local area connection 146 through router 190.

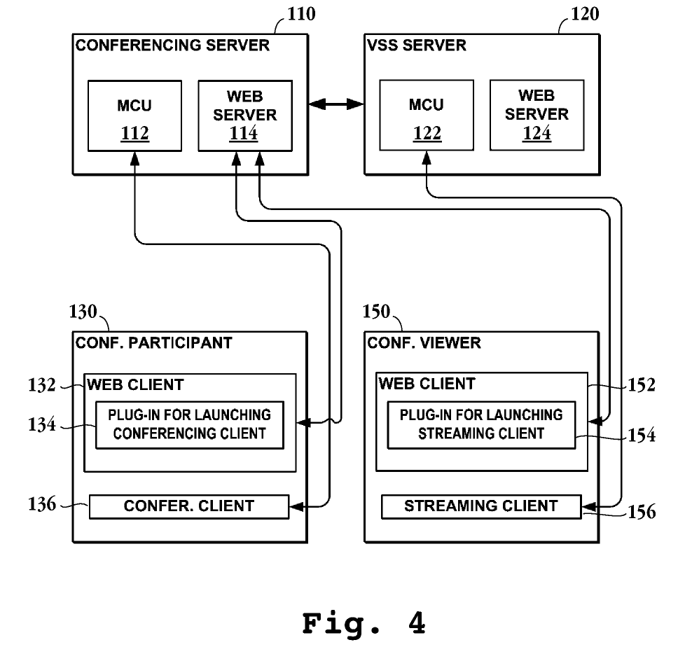

FIG. 4 shows a schematic block diagram showing high-level software components of the various computers interacting to provide conferencing system 100 of FIGS. 1 and 3. As mentioned previously, the system shown is exemplary, and various server components may be spread across additional server computers or combined into fewer computers. Functionality provided by multiple software applications may be combined into a fewer applications or divided into a greater number of applications, depending on the implementation. In the present example, conferencing server 110 and VSS server 120 each include a multipoint control unit (MCU) server 112, 122 and a web server 114, 124. In one embodiment, web server 114 serves as a portal to the conferencing system for both the conference participant 130 and the conference viewer 150.

For the conference participant, once the user is authenticated, web server 114 triggers browser plug-in 134 which launches conferencing client 136. The browser plug-in is provided with the IP address of MCU server 112 and an authentication token or other authentication information. In one embodiment, web server 114 provides MCU server 112 with complimentary authentication information, such as a key, with which MCU server can authenticate conference participant 130 when contacted by conferencing client 136. For the conference viewer, after authentication by logging in with web server 114, web server triggers browser plug-in 154 which launches streaming client 156. Web server 114 provides browser plug-in 154 with the IP address of MCU server 122 in VSS server 120, for receiving the streaming content. In addition, an authentication token or other authentication information is provided to browser plug-in 154, and complimentary authentication information may be provided to MCU server 122 via LAN connection 146. The IP address and authentication information are passed to streaming client 156 to enable a secure log-in with MCU server 122.

Authentication may be achieved in other ways. For example, authentication may use a public key encryption scheme whereby web server 114 passes an encrypted, digitally signed message to either conference participant 130 or conference viewer 150 after authentication with web server 114, which message is then relayed to the appropriate one of MCU servers 112, 122, which solely holds the private key for decrypting the message, which could contain user information. The MCU server can authenticate the message by authenticating the digital signature. This would allow MCU servers 122, 124 to authenticate users without having to compare certificates with separate information supplied by web server 114. It should also be noted that conference participant 130 and conference viewer 150 may be provided with identical software such that conferencing client 136 and viewing client 156 are actually the same computer program that operate in either a conferencing mode or a viewing mode.

VSS server 120 also has a web server 124 which provides an administration interface. Web server 124 can therefore be used to provide various information and controls relating to MCU server 122 to remote administrators (not shown). Once a connection is made between conference viewer 150 and VSS 120, the conference viewer may begin receiving real-time streaming data from VSS as the data is received from MCU server 110.

Web server 114 will know if a connection is a conference participant or conference viewer by the username. Upon a valid connection, when the web server identifies that the connection is for a conference viewer, the web server redirects the client to VSS 120. This occurs by launching the client, placing the client in viewer mode, and letting it know the IP address of VSS 120. As mentioned, the authentication token is also passed to the client. The same process occurs for a conference participant, except the IP address of MCU server 112 is passed to the client and the security key is sent to MCU server 112 instead of VSS 120.

In one embodiment, meetings with both participants and viewers are created using a create-meeting web page (not shown). The web page may have a link that allows a meeting owner to add streaming users to the meeting. The web server will know that the meeting includes conference viewers if conference viewers are added to the meeting. In clicking the “Add Streaming Users” link, the web server will bring up a web page (not shown) for adding conference viewers. By default, the meeting owner will be the controller. However, the web page may allow the meeting controller/owner to designate a different controller. In one embodiment, the controller must be a conference participant and not a conference viewer. In another embodiment, the controller may be either a participant or a viewer. The controller will have access to the control panel, described below with reference to FIG. 7.

Because conference viewers 150 may have varying bandwidth availability to receive multimedia data, and because the bandwidth may fluctuate over time, it may be desired to control the bit rate of video data transmitted from VSS server 120 to the conference viewers 150. In one embodiment, the bit rate is controlled while at the same time limiting the amount of encoding/decoding of the audio and video streams by the VSS. The bitrate may be controlled as described in related U.S. patent application Ser. No. 11/051,674 filed on Feb. 4, 2005 and entitled “Adaptive Bit-Rate Adjustment of Multimedia Communications Channels Using Transport Control Protocol,” incorporated herein by reference.

In one embodiment, the audio is a fixed bit rate, so no changes are made to the way audio is currently handled. However, the video is provided to conference viewers 150 in one of a plurality of bit rates. The incoming stream from MCU SERVER 112 is replicated and sent to each streaming client. If all connections and client PC's are of comparable performance levels then the video could be sent to each client without decoding and encoding. However, if there is a fast client with a fast connection and a slow client with a slow connection, they cannot be sent the video data at the same rate. To solve this problem, there is, in one embodiment, three predetermined video bit rates: slow, medium, and fast. Each video bit rate corresponds to the maximum bit rate of a video frame and the frame rate. MCU server 112 sends the highest bit rate to VSS 120. VSS 120 then decodes the video and re-encodes the video for the two smaller bit rates if needed.

If it is determined that a connection cannot keep up with the current bit rate then the data sent on that stream will be dropped down to the next lower bit rate of the three fixed rates. At this stepped-down bit rate, an intraframe will be generated and sent to all streaming clients of the same bit rate. As is generally known to those skilled in the art, an intraframe, also referred to as “I-frame” or “key frame,” is frame of video encoded in such a way that it does not require information from preceding frames to decode it, i.e., it includes all the data necessary to display that frame. By providing an intraframe to all the streaming clients of the same bit rate, each client's video will be up to date and have the needed data to compose the succeeding frames. To determine when to drop a client down to a lower bit rate, congestion code can be used, the congestion code being a measurement of latency of the connection. There could be times when the bit rate does not need to be reduced, as there is only a blip in the connection's bandwidth, e.g., due to temporary congestion. At this point, the data going out the line could be reset. Resetting effectively pauses the data going out that connection, generating an intraframe (it will be sent to all connections of the same bit rate), and resume sending the data on that line. To select the initial bit rate, the bit rate of the connection will be measured and the next smallest of the three predetermined bit rates will be used.

In one embodiment, VSS 120 controls each stream and the distribution of H.323 data to each client. H.323 is an encoder-decoder (“codec”) and specification from the ITU Telecommunication Standardization Sector (ITU-T). H.323 is an industry standard codec and protocol to provide audio-visual communication sessions on any packet network. In one embodiment, only one video stream is sent from MCU server 112 to VSS 120. This video stream is chosen from the VSS control panel in the manner described below with reference to FIG. 7. Allowing only one video stream improves quality by not needing to decode and encode a mixed video signal. Any decoding and re-encoding visibly diminishes the video quality. Allowing only one video stream is also a performance enhancement. MCU server 112 does not have to mix in the data from the other video streams and the data can be passed from the selected conference participant straight through to the VSS without decoding and re-encoding.

In one embodiment, the bit rate from MCU server 112 to VSS 120 will be maintained very high to keep the video at a high quality. In this case, LAN connection 146 is assumed to be able to sustain high data rates, e.g., at or close to 10 or 100 Mbps. Of course, the quality provided by the MCU server may be selected based on the speed of the LAN connection to ensure real-time data delivery. In various embodiments, the quality of the video may be selected depending on the available LAN bandwidth. This reduces degradation caused by decoding and re-encoding to a minimum since the VSS might have to re-encode for the reduced bit rates. In implementations where the connection between MCU server 112 and VSS 120 has restricted bandwidth, this restriction can be dropped at a cost to video quality. VSS 120 may replicate HTTP connections to the conference viewers as described below for delivering supplemental content to the conference viewers. For example, the HTTP connection is used for transferring image and data files to the clients. Upon receiving any HTTP data to the VSS, the VSS will forward that data to each streaming client.

The VSS may negotiate the same video and audio codecs for all streaming clients. In one embodiment, supported codecs include at a minimum H.263 video and G.711 speech codecs published by the ITU-T or some other standard protocol the VSS negotiates. These same protocols may be used for the VSS to MCU streams also.

Conference viewers 150 are not limited to receiving streaming audio and video. In addition, application sharing data, images and documents, and annotations, along with other multimedia content may be delivered to the conference viewers. In one embodiment, streaming clients may download images or documents from VSS 120 by making an HTTP connection to VSS 120. VSS 120 may then forward this request to web server 114. VSS 120 in this case acts as a proxy for the streaming client. However, the HTTP requests are not blindly forwarded to web server 114. Rather they are transformed to show the origination is from VSS 120. As VSS 120 collects data from the HTTP requests to the web server, VSS 120 can send the data onto the streaming client as the result of its HTTP request. In addition, conference viewers may be permitted to send text messages to each other, to the group at large, and/or to the controller.

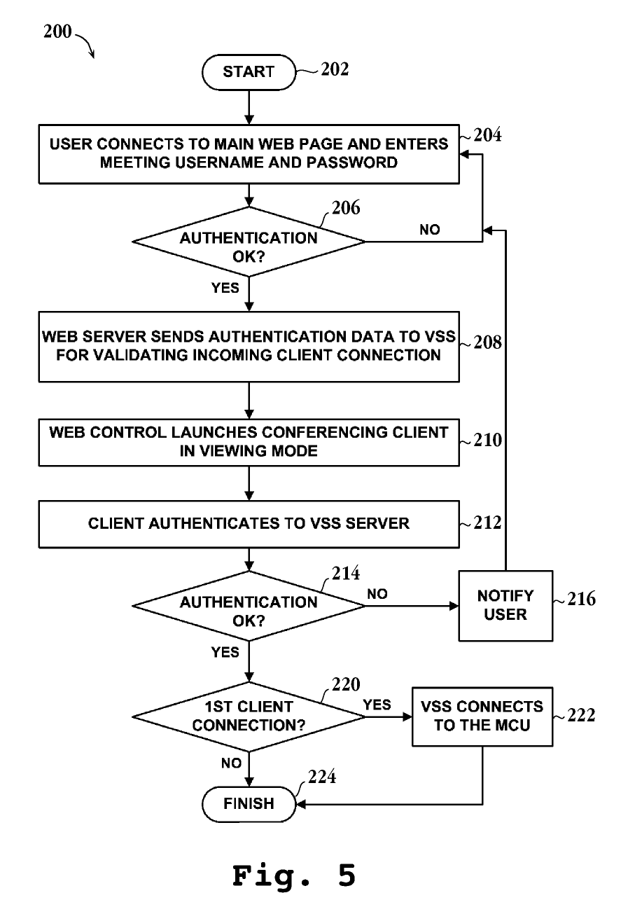

FIG. 5 shows a flowchart 200 describing an exemplary procedure for accessing VSS server 120 to passively participate in a conference. The procedure begins as indicated by start block 202 and proceeds to operation 204 wherein the user connects to web server 114 to access a main log-in web page provided by the server. As is commonly known for web authentication, the user's web client 134 presents the user with a text box within which to enter his or her username and password. This information may then be encrypted and sent over a TCP/IP connection with transport layer security (TLS) encryption, a known encryption standard. After the user connects to web server 114 and enters authentication information, the procedure flows to operation 206.

In operation 206, it is determined whether the authentication is acceptable. For example, the authentication may be compared with a list of attendees for each online conference, or each conference may simply have an identifier and password, such that any person possessing the identifier and password, would be authenticated. In the latter case, the user may then be required to enter a name or select a name from a predefined list so that they can be identified by the system and other participants and users. It is also possible to provide a single password to identify the particular conference and a separate username for each attendee. If the authentication information entered by a user is matches previously stored authentication information, then the authentication is acceptable. Otherwise, the authentication would be rejected. If the authentication is rejected, then the procedure flows back to operation 204 to give the user an opportunity to re-enter the information. In one embodiment, the user is only permitted to enter authentication information a limited number of times before being locked out as a security precaution. If the authentication information is acceptable, e.g., matches previously stored authentication information, then the procedure flows to operation 208.

In operation 208, web server 114 sends authentication data to VSS 120 so that VSS 120 can validate the incoming VSS client connection. Note that this procedure is specifically for conference viewers. If the username had matched a conference participant, then the web server would connect the user to the MCU as described above with reference to FIG. 4. In operation 210, the web control or plug-in 154 is triggered by web server 114 and launches streaming client 156. In operation 212, streaming client 156 connects to VSS 120 and authenticates using validation information and an IP address passed to the client from the control, which ultimately received the information from web server 114.

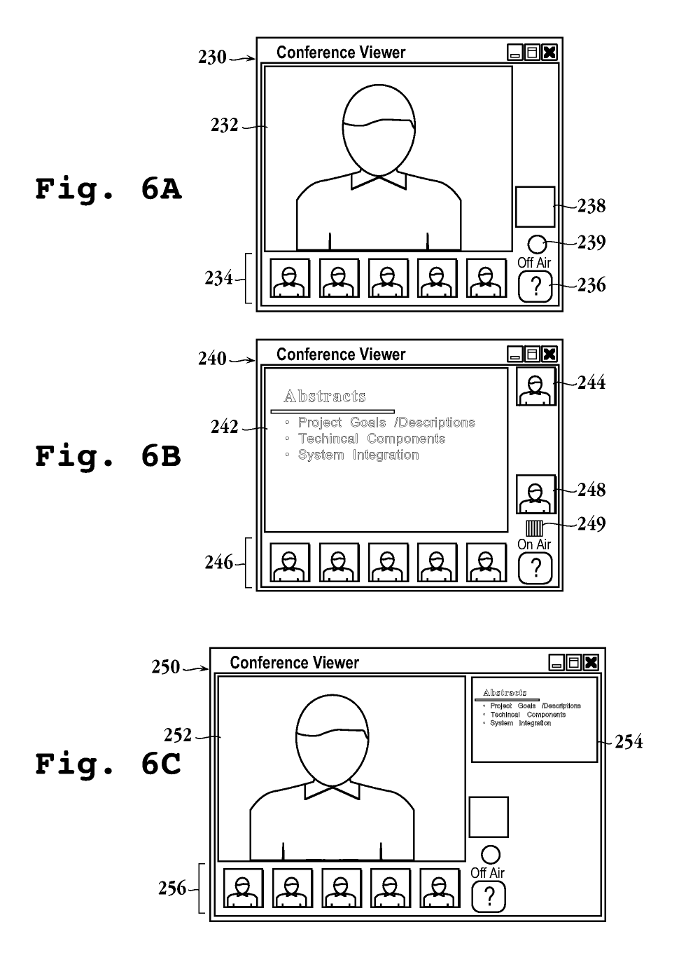

If the authentication information sent from streaming client 156 is not acceptable, then the procedure returns to operation 204 to allow the user to enter different authentication information. On the other hand, if the authentication is acceptable, then the procedure flows to operation 220 wherein it is determined whether this is the first client to connect to VSS 120. If so, then the VSS connects to the MCU to begin receiving streaming data therefrom for conference viewer 150. The procedure then ends as indicated by finish block 224. If, in operation 220, it is determined that the client is not the first client to connect, then the procedure flows directly to finish block 224. Once the user is connected to the streaming client, he or she can view the conference as a conference viewer, as shown in FIGS. 6A-6C.

In one embodiment, streaming client 156 operates in one of three modes: a video mode, a data mode, or a mixed mode. FIGS. 6A, 6B, and 6C show exemplary graphical user interface configurations for each of these modes. It should be understood that these configurations are exemplary only, and that other configurations may be provided. FIG. 6A shows an exemplary graphical interface 230 for streaming client 156 when operating in video mode. In video mode, streaming client 156 shows a main presenter video 232 and thumbnails 234 of the other presenters. If network bandwidth permits, the main presenter video 232 will be full size video (e.g. 320 pixels by 240 pixels) with at a high frame rate (e.g. 10-15 frames per second (fps)). This would be for good network conditions and might not be reached due to network traffic or other bandwidth limitations. Due to bandwidth limitations, the resolution and/or frame rate may be reduced, e.g., as described in related U.S. patent application Ser. No. 11/051,674 filed on Feb. 4, 2005 and entitled “Adaptive Bit-Rate Adjustment of Multimedia Communications Channels Using Transport Control Protocol,” incorporated herein by reference.

Thumbnails 234 of the other presenters are “live” and show low bit-rate snapshots of that presenter. For example, in one embodiment, the thumbnails are updated less than once per second and are of small size (e.g. 64 pixels by 64 pixels). In one embodiment, thumbnails 234 are displayed on a strip at the bottom of the display area, although other configurations are possible. Graphical interface 230 also includes a question button 236 to indicate to the controller a desire to ask a question. As will be described in more detail below with reference to FIG. 7, when a passive user clicks on question button 236, an icon is displayed in the controller's control panel. The controller can then open the user's microphone and send audio or audio and video from the passive user to the active (and passive) participants so that they can respond. The user is informed that he or she is “on the air” i.e., his audio and/or video is being transmitted to the group at large, by way of an “on-air” icon 239 and a thumbnail 238 image of the user is looped back to the user so that he or she can see what is being transmitted to the group.

In the data mode, shown by way of example in FIG. 6B, graphical user interface 240 displays a document 242 along with main presenter 244 and other presenters 246. The main portion of the display will be filled with the document 242. The document can be such things as PowerPoint slides, images, or a live view of the main presenter's computer desktop, which can then be used to display a slide presentation, a computer program, a word processor document, etc. In data mode, the main presenter 244 is switched from a video stream to low rate thumbnail mode. The thumbnail mode is a small size image (e.g. 64 pixels by 64 pixels) that is updated less than once per second. Main presenter 244 may be set off to the side of the document to differentiate him from other presenters 246 and to associate him with the document. Other presenters 246 may also be in thumbnail mode at a strip along the bottom of the main display area. As shown in FIG. 6B, the user is “on the air” and thumbnail 248 of the user is provided and on-air indicator 249 will indicate that other active and passive users are receiving audio and video data from the user's microphone and video capture device. This allows the passive user to ask a question of the conference participants when permitted to do so by the controller.

FIG. 6C shows graphical user interface 250 with a mixed mode presentation. In this mode, main presenter 252, other presenters 256, and a small view of the document 254 is displayed. This mode may be used to help keep the documents and main presenter in context. If the meeting is in data mode, e.g., showing a slide show presentation, and becomes important to see the motion of the main presenter, then this mode can be used. The users can see the main speaker 252 in the main display area, yet can also see the document 254 thus keeping the presentation in its proper context.

In the mixed mode, the document and video might need to be transmitted at the same time. This may result in reduced video quality and frame rate due to bandwidth limitations while a document is being transmitted to all the clients. In one embodiment, if bandwidth is fully available, high quality video, at full size (e.g. 320×240) is displayed at a high frame rate (e.g., 10 fps). This may be the goal under ideal network conditions. Due to network conditions, this goal might not be reached and may be reduced as described in the related U.S. Patent Application entitled “Adaptive Bitrate Adjustment of Multimedia Communications Channel over TCP (temporary title)”. The other presenters 196 are shown in the usual thumbnail mode, e.g., 64 pixels by 64 pixels updated once per second or less, at the bottom of the display area. A small view of the document 254 may be shown to the right of the video being displayed.

FIG. 7 shows an exemplary control panel interface 260 for the control panel client running on controller 140 (FIG. 1). The control panel client interfaces with conferencing server 110 and VSS 120 and manages the streaming clients 156. To control what the streaming clients see, a controller will use the Video Streaming Server Control Panel. The control panel will let the moderator choose who the main presenter is and control which streaming client can ask a question. The control panel is a small application that may be used to control the streaming sessions. In one embodiment, it may be run on the same PC as the controlling client 140 (FIG. 1). Controlling client 140 can launch (or launch from) this application once the client has been setup as the streaming controller.

The main purpose of the Video Streaming Server (VSS) control panel will be to manage the questions from streaming clients. The control panel will have to establish a connection to the VSS. The data needed from the VSS will be the name of each connected client, its question state, the audio levels, and the network quality levels. A connection to the Web Server Document Channel will need to be established to authenticate the connection. The control panel has a list 262 of each client connected to VSS 120. Along with the name of the client connected will be an indicator 264 showing whether there is a question from that client.

The control panel can be used to select which client can ask a question. A thumbnail view of the current questioner will be transmitted along with the audio. Note, it is the controller that controls how many streaming clients can ask a question at the same time. The moderator will also be able to control which questioner shows up in the thumbnail view. In one embodiment, the control panel has audio and network indicators 266 for each client. This may help in diagnosing audio and network problems that will come up. In one embodiment, the control panel is written in the JAVA programming language.

In one embodiment, each conference viewer 150 may request permission to ask a question of the conference participants 130. The request is sent to VSS 120 and forwarded to the control panel 260. The controller can then approve the request at his or her convenience. The approval needs is then sent to VSS 120 and forwarded to the issuing client 150. The client may also cancel the request. In one embodiment, there may be only one streaming client approved to ask questions at a time. The protocol may be a simple request/granting protocol. Whichever client has their request granted will be able to ask questions. The question state of each client is maintained by VSS 120. The state can be none, requesting, canceling, or approved. At startup, control panel 260 can query the questioning state of each client. When the VSS receives an approve request from the control panel, it will then allow audio from the client that issued the request. If VSS 120 receives a cancel request from a streaming client that has the audio enabled, the VSS will disable that client's audio and set question state its state to none.

In one embodiment, the control panel displays the audio levels 268. This may aid in helping the moderator diagnose audio problems to the streaming clients. The indicators will show the network quality and signal strength of the audio being sent to the streaming clients. Each streaming client that is listed in the control panel will have it own audio indicator. To help determine whether a particular communications problem relates to a network problem, whether the speakers turned on, whether the microphone on, whether the Microsoft Windows® control panel settings are correct, etc., the streaming system may have a test mode.

In the test mode, the controller can determine whether all conference viewers are connected and working properly. The controller can check audio to the streaming clients, video to the streaming clients, and audio from the streaming clients. In one embodiment, the test mode is started from the control panel by clicking a test mode button 270. Upon entering test mode, the conference viewer's user interface will change into test mode. The question button 236 (FIG. 6A) and indicators will go away and be replaced by the test mode information (not shown). The test mode will ask the user to check a check box if they can here audio. It will ask the user to check a check box if they can see video. The times these buttons are checked will be recorded and displayed. This information will show up on the control panel line item 272 (FIG. 7) for that client. There will also be a check box if there is a problem with either the audio or video connection. This way, the controller can quickly see who may be experiencing a problem.

To help in diagnosing audio and network problems, audio and network levels 266 may be shown on the line item for that client. Also the bit rate of each client will be listed along with the bit rate level (slow, medium, fast) in the line item for that client.

During the start of a meeting or during the audio/video check, it might be determined that a conference viewer should actually be a conference participant or visa-versa. The control panel 260 will have the ability to change the client from one mode to the other. This might involve shutting down the client and its connection and restarting the client in the new mode.

Often at the end of a presentation there is a question answer period. In one embodiment, one conference viewer may ask a question at a time. To ask a question the user of a streaming client 156 will click a button 236 (FIG. 6A) on the user interface. An indicator 264 on the controller's control panel 260 indicates that that user has a question. Then upon approval by the moderator, the user may ask the question. The person asking a question will be viewed on each client in thumbnail mode (e.g. 64 pixels by 64 pixels at about less than one frame per second). In other embodiments, a still image may be used to represent the person asking a question. The image may be a photograph of the person, or some other icon representing the person. The image may be designated by the controller, or may be provided by the conference viewer him- or herself.

FIG. 8 shows a swim lane diagram 280 providing an exemplary interaction when a question is being requested. Initially, a conference viewer indicates a desire to ask a question by sending a message 282 to VSS 120. VSS 120 forwards the request to control panel 160 by sending message 284. If the controller approves the request, then an approval message 286 is sent back to VSS 120. VSS 120 then sends a message 288 to the conference viewer that the request is approved, and a message 290 confirming that the state of the conference viewer has been updated to approved. Other enhancements may be made to this system. For example, message 282 may include a text comment by the requester that provides an indication as to the subject of the question. This will allow the controller to more intelligently decide who to approve to ask a question when multiple participants have requested a question. For example, if the question was just answered or was already addressed, the controller can pick a different person to ask a question. In this manner, questioners can be pre-screened.

With the above embodiments in mind, it should be understood that the invention can employ various computer-implemented operations involving data stored in computer systems. These operations are those requiring physical manipulation of physical quantities. Usually, though not necessarily, these quantities take the form of electrical or magnetic signals capable of being stored, transferred, combined, compared and otherwise manipulated. Further, the manipulations performed are often referred to in terms such as producing, identifying, determining, or comparing.

Any of the operations described herein that form part of the invention are useful machine operations. The invention also relates to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data, which can be thereafter be read by a computer system. Examples of the computer readable medium include hard drives, network attached storage (NAS), read-only memory, random-access memory, CD-ROMs, CD-Rs, CD-RWs, magnetic tapes and other optical and non-optical data storage devices. The computer readable medium can also be distributed over a network-coupled computer system so that the computer readable code is stored and executed in a distributed fashion.

Embodiments of the present invention can be processed on a single computer, or using multiple computers or computer components which are interconnected. A computer, as used herein, shall include a standalone computer system having its own processor(s), its own memory, and its own storage, or a distributed computing system, which provides computer resources to a networked terminal. In some distributed computing systems, users of a computer system may actually be accessing component parts that are shared among a number of users. The users can therefore access a virtual computer over a network, which will appear to the user as a single computer customized and dedicated for a single user.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A conferencing method comprising method operations including:
connecting a plurality of conference participants to a conferencing server using a first plurality of network connections, the plurality of conference participants generating conferencing content and sending the conferencing content to the conferencing server along the first plurality of network connections;
connecting a plurality of conference viewers to a video streaming server using a second plurality of network connections;
passing at least a portion of the conferencing content from the conferencing server to the video streaming server; and
streaming the portion of the conferencing content to the plurality of conference viewers using the second plurality of network connections.

2. The conferencing method of claim 1, wherein the conferencing content includes at least an audio stream from each of the conference participants.

3. The conferencing method of claim 1, wherein the conferencing content includes at least an audio-video stream from one of the conference participants, and the portion of the conferencing content passed to the video streaming server includes the audio-video stream from the one of the conference participants.

4. The conferencing method of claim 3, wherein the portion of the conferencing content further comprises thumbnail images of each of the conference participants, the thumbnail images being updated periodically.

5. The conferencing method of claim 1, further comprising:
connecting a control panel to the conferencing server using a network connection; and
receiving a message by the conferencing server from the control panel, the message identifying which portion of the conferencing content to pass to the video streaming server, wherein the portion passed to the video streaming server corresponds to the portion identified in the message.

6. The conferencing method of claim 1, wherein the portion of conferencing content includes a video stream of a presenter, and document data, the conferencing method further comprising:
connecting a control panel to the video streaming server using a network connection; and
receiving a message by the video streaming server from the control panel, the message identifying a mode selection, wherein in response to a first mode selection, the video stream is transmitted to the conference viewers at a first bit rate, and in response to a second mode selection, the video stream is transmitted to the conference viewers at a second bit rate, the second bit rate being less than the first bit rate, the video streaming server also transmitting document data to the plurality of conference viewers in response to the second mode selection.

7. The conferencing method of claim 6, wherein in response to a third mode selection, the video stream is transmitted at the first bitrate, and the document data is transmitted to the plurality of conference viewers.

8. The conferencing method of claim 1, further comprising:
connecting a control panel to the video streaming server using a network connection;
receiving a request from at least one of the conference viewers, the request indicating a desire to ask a question of the conference participants;
passing the request to the control panel;
receiving a message from the control panel identifying a conference viewer, the message granting permission to the conference viewer to ask a question;
passing multimedia data from the conference viewer identified by the message to the conferencing server, the conferencing server passing the multimedia data to the conference participants.

9. The conferencing method of claim 1, further comprising:
receiving a log-in request by a web server from a web client;
authenticating a user of the web client, the authentication including identifying a username;
triggering a control installed on the web client to launch a conferencing client when the authentication is successful, wherein the triggering comprises passing an authentication token and an internet protocol (IP) address to the web client, the IP address being an IP address of the conferencing server if the username is included in a list of conference participants, and an IP address of the video streaming server if the username is included in a list of conference viewers.

10. The conferencing method of claim 1, wherein each of the method operations is embodied in a machine readable medium as a series of computer instructions for implementing the method on a plurality of computers connected via a network.

11. The conferencing method of claim 1, wherein the streaming comprises:
transmitting the portion of the conferencing content at one of three predetermined bit rates;
identifying a lagging connection, the lagging connection being identified by increased latency of the connection;
dropping down the lagging connection to a next lower bit rate of the three predetermined bit rates, wherein the portion of the conferencing content is decoded and re-encoded for the next lower bit rate.

12. A conferencing system, comprising:
a conferencing server programmed for accepting a plurality of connections from a corresponding plurality of conference participants, the conferencing server receiving multimedia content from each of the conference participants;
the conferencing server being further programmed for accepting a connection from a controlling client, the conferencing server receiving a message from the controlling client, the message designating one of the conference participants; and
the conferencing server being further programmed for passing multimedia content from the designated conference participants to a video streaming server.

13. The conferencing system of claim 12, wherein the conferencing server responds to a subsequent message from the controlling client containing a subsequent designation of a different one of the conference participants by switching a source of the multimedia content passed from the designated conference participant to the different one of the conference participants.

14. The conferencing system of claim 12, wherein the multimedia content includes at least an audio stream from each of the conference participants.

15. The conferencing system of claim 12, wherein the multimedia content from the designated conference participant includes at least an audio-video stream.

16. The conferencing system of claim 15, wherein the multimedia content further comprises document data.

17. The conferencing system of claim 12, wherein the conferencing server is further programmed to receive a log-in request by a web server from a web client, the conferencing server authenticating a user of the web client, the authentication including identifying a username, the conferencing server triggering a control installed on the web client causing the control to launch a conferencing client when the authentication is successful, wherein the triggering comprises passing an authentication token and an internet protocol (IP) address to the web client, the IP address being an IP address of the conferencing server if the username is included in a list of conference participants, and an IP address of the video streaming server if the username is included in a list of conference viewers.

18. A conferencing system comprising:
a video streaming server (VSS) programmed for accepting a plurality of network connections from a corresponding plurality of conference viewers;
the VSS being further programmed to communicate with a multipoint control unit (MCU) server over a network and to receive multimedia content from the MCU server, the VSS streaming the multimedia content to the plurality of conference viewers using the plurality of network connections;
the VSS further being further programmed to communicate with a control panel, the VSS receiving question requests from the plurality of conference viewers and sending the question requests to the control panel, the VSS further receiving a message from the control panel, the message identifying one of the conference viewers to ask a question;
the VSS being further programmed to receive multimedia data from the identified conference viewer and pass the multimedia data to the MCU server, the multimedia data comprising at least an audio stream.

19. The conferencing system of claim 18, wherein the multimedia content includes a video stream from a conference participant and document data, the VSS being further programmed to receive a message from the control panel, the message identifying a mode selection, wherein in response to one mode selection, the video stream is transmitted to the conference viewers at a first bit rate, and in response to a second mode selection, the video stream is transmitted to the conference viewers at a second bit rate, the second bit rate being less than the first bit rate, the video streaming server also transmitting document data to the plurality of conference viewers in response to the second mode selection.

20. The conferencing system of claim 19, wherein in response to a third mode selection, the video stream is transmitted at the first bitrate, and the document data is transmitted to the plurality of conference viewers.
